(19) United States
(12) Patent Application Publication
(10) Pub. No.: US 2026/0277840 A1
(43) Pub. Date: Sep. 17, 2026

(54) NETWORK INFRASTRUCTURE INCLUDING INTERCONNECTED SYSTEM-ON-PACKAGE (SOP) STRUCTURES WITH BUILT-IN ACCELERATORS AND SWITCHES

(71) Applicant: MIPS Tech, LLC, San Jose, CA (US)

(72) Inventors: Prakash C. Jain, Fremont, CA (US); Durgesh Srivastava, Cupertino, CA (US)

(21) Appl. No.: 19/565,155

(22) Filed: Mar. 12, 2026

Related U.S. Application Data
(60) Provisional application No. 63/771,472, filed on Mar. 13, 2025.

(51) Int. Cl. G06F 13/40

(52) U.S. Cl. CPC G06F 13/4022

(57) ABSTRACT

A structure and, particularly, a network infrastructure for a data center backend network includes networked compute clusters (CCs). Each CC includes multiple nodes. Each node includes an arrangement of interconnected system-on-package (SOP) structures. In a network infrastructure with a scale-up topology, the network infrastructure, each SOP structures can have similar configurations. For example, each SOP structure can include: switch ports; network ports; and a network subsystems block. The network subsystems block can include switch subsystems (i.e., switches) coupled to the switch ports, respectively; network interface subsystems coupled to the network ports, respectively; and an accelerator coupled to the switch subsystems and the network interface subsystems. The network infrastructure can further include network port-to-switch port interfaces between the SOP structures. In other network infrastructure embodiments with a combined scale-up and scale-out topology, some of the SOP structures within the arrangement of interconnected SOP structures may have different configurations.

### BACKGROUND

The present disclosure relates to data center backend networks and, more particularly, to embodiments of a structure and, particularly, a network infrastructure for a data center backend network including an arrangement of interconnected system-on-package (SOP) structures with built-in accelerators and switches to facilitate efficient and cost-effective communications across a compute cluster employed, for example, in artificial intelligence (AI) and/or machine learning (ML) applications.

Compute resources and, particularly, graphic processing units (GPUs) and accelerators in data center backend networks have become the backbone of artificial intelligence (AI) and machine learning (ML) training and inference. As technology advances these networks no longer simply provide connectivity. They have become a critical performance driver for AI/ML processing. Unfortunately, conventional techniques for building the network infrastructure of end-to-end data center networks may now be cost prohibitive. This is due to the vast numbers of compute resources needed to meet the performance demands of modern AI/ML processing (e.g., low latency, lossless real-time communication for remote memory access, etc.) and, particularly, the high cost of external switches and optics required for interconnecting those compute resources to meet the performance demands.

### SUMMARY

Disclosed herein are embodiments of a structure. In some embodiments, the structure can include multiple system-on-package (SOP) structures. These SOP structures can have similar configurations. For example, each SOP structure can include: switch ports and network ports. Each SOP structure can further include a network subsystems block including multiple network subsystems. The subsystems can include switch subsystems (i.e., switches) coupled to the switch ports, respectively; network interface subsystems coupled to the network ports, respectively; and an accelerator coupled to the switch subsystems and the network interface subsystems. The structure can further include network port-to-switch port interfaces between the SOP structures.

In other embodiments, the structure can include multiple system-on-package (SOP) structures and at least some of the multiple SOP structures can have different configurations. For example, the SOP structures can include one SOP structure with scale-out switch ports. This SOP structure can further include a network subsystems block, which includes scale-out switch subsystems (i.e., scale-out switches) coupled to the scale-out switch ports, respectively, and an accelerator coupled to the scale-out switch subsystems. The SOP structures can include multiple additional SOP structures. Each additional SOP structure can include: a scale-out network port; scale-up network ports; and scale-up switch ports. Each additional SOP structure can also include an additional network subsystems block. The additional network subsystems block can include: a scale-out network interface subsystem coupled to the scale-out network port; scale-up network interface subsystems coupled to the scale-up network ports, respectively; scale-up switch subsystems (i.e., scale-up switches) coupled to the scale-up switch ports, respectively; and an additional accelerator coupled to the scale-out network interface subsystem, the scale-up network interface subsystems, and the scale-up switch subsystems. The structure can further include scale-out network port-to-scale-out switch port interfaces between the SOP structure and each of the additional SOP structures; and scale-up network port-to-scale-up switch port interfaces between the additional SOP structures.

It should be noted that all aspects, examples, and features of disclosed embodiments mentioned in the summary above can be combined in any technically possible way. That is, two or more aspects of any of the disclosed embodiments, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The present disclosure will be better understood from the following detailed description with reference to the drawings, which are not necessarily drawn to scale and in which:

FIG. 1A is a schematic diagram illustrating an end-to-end data center network including a data center backend network with multiple compute clusters (CCs) interconnected by a scale-out network and, within each CC, multiple nodes interconnected by another network (e.g., a scale-up network or, alternatively, a combined scale-up and scale-out network);

FIG. 1B is a schematic diagram generally illustrating disclosed embodiments of a system-on-package (SOP) structure that can be integrated into nodes, respectively, of a network within a CC;

FIG. 2 is a schematic diagram illustrating, in greater detail, a portion of one example of an SOP structure;

FIG. 3 is a schematic diagram illustrating disclosed embodiments of a structure and, particularly, a scale-up network infrastructure including an arrangement of multiple interconnected SOP structures (e.g., as shown in FIG. 2) for multiple nodes, respectively;

FIG. 4 is a schematic diagram illustrating, in greater detail, a portion of another example of SOP structure;

FIG. 5 is a schematic diagram illustrating, in greater detail, a portion of yet another example of an SOP structure;

FIG. 6 is a schematic diagram illustrating, in greater detail, a portion of yet another example of an SOP structure;

FIG. 7 is a schematic diagram illustrating other embodiments of a structure and, particularly, a combined scale-up and scale-out network infrastructure including an arrangement of multiple interconnected SOP structures (e.g., including one instance of the SOP structure shown in FIG. 4 and multiple instances of the SOP structures shown in FIGS. 5 and 6) for multiple nodes, respectively; and

FIG. 8 is a schematic diagram illustrating an example hardware environment for implementing aspects of the disclosed data center backend network, methods and computer program products.

### DETAILED DESCRIPTION

As mentioned above, compute resources and, particularly, graphic processing units (GPUs) and accelerators in data center backend networks have become the backbone of artificial intelligence (AI) and machine learning (ML) training and inference. As technology advances these networks no longer simply provide connectivity. They have become a critical performance driver for AI/ML processing. Unfortunately, conventional techniques for building the network infrastructure of end-to-end data center networks may now be cost prohibitive. This is due to the vast numbers of compute resources needed to meet the performance demands of modern AI/ML processing (e.g., low latency, lossless real-time communication for remote memory access, etc.) and, particularly, the high cost of external switches and optics required for interconnecting those compute resources to meet the performance demands.

In view of the foregoing, disclosed herein are embodiments of a structure and, particularly, a network infrastructure for a data center backend network. The data center backend network can include multiple compute clusters (CCs) (e.g., performance optimized data centers (PODS)), which are interconnected (e.g., over a scale-out network). Each CC can include multiple nodes. Each node can include a system-on-package (SOP) structure with components configured for performing various distributed, high-performance tasks for artificial intelligence (AI) and machine learning (ML) applications. In the disclosed embodiments, the network infrastructure within a CC can include an arrangement of interconnected system-on-package (SOP) structures, each having a corresponding network subsystems block including, but not limited to, an accelerator and switch subsystems to support (i.e., to enable and facilitate) efficient and cost-effective communication between the SOP structures and, particularly between the accelerators in the different SOP structures. In some network infrastructure embodiments with a scale-up topology, all SOP structures within the arrangement of interconnected SOP structures may have the same configuration (including, for example, network ports, switch ports, and a network subsystems block including network interface subsystems coupled to the network ports, switch subsystems coupled to the switch ports, and an accelerator coupled to the network interface subsystems and to the switch subsystems). In other network infrastructure embodiments with a combined scale-up and scale-out topology, some of the SOP structures within the arrangement of interconnected SOP structures may have different configurations (as discussed in greater detail below). In any case, in each of the network infrastructure embodiments, the arrangement of interconnected SOP structures and the built-in subsystems within the network subsystems block support (i.e., enables and facilitates) across compute/accelerator communication. In some embodiments (as discussed in greater detail below), such communications can be achieved using internal interconnects (e.g., silicon photonics) without the need (or with only limited need) for external interconnects (e.g., costly external switches, copper wires, fiber modules, and/or optical interfaces).

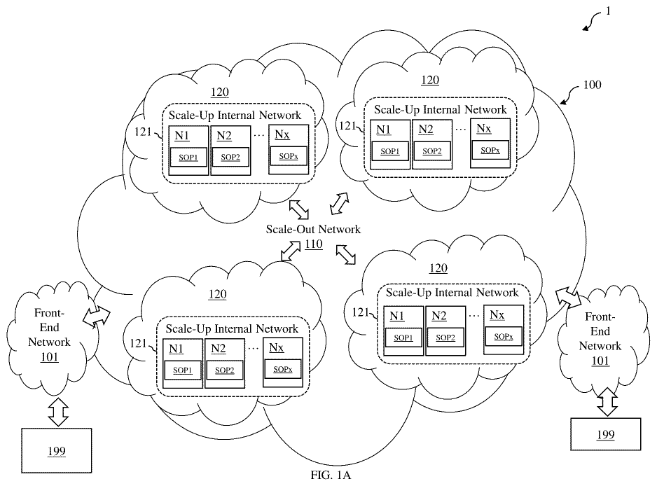

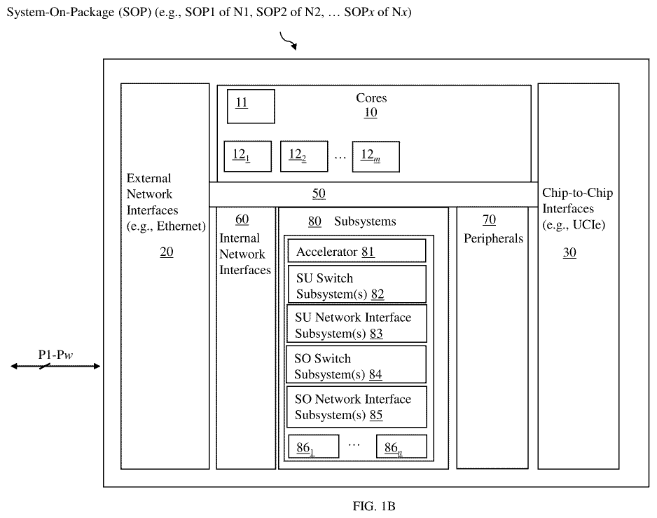

FIG. 1A is a schematic diagram generally illustrating an end-to-end data center network 1 including a data center backend network 100 with multiple compute clusters (CCs) interconnected, for example, by a scale-out network 110 and, within each CC, multiple nodes N1-Nx interconnected by another network (e.g., a scale-up network or a combined scale-up and scale-out network). FIG. 1B is a schematic diagram generally illustrating embodiments of a system-on-package (SOP) structure that can be integrated into the nodes, respectively, within a network of a CC.

More specifically, FIG. 1A illustrates an example of an end-to-end data center network 1 for an AI or ML networking application. End-to-end data center network 1 can include a data center backend network 100 (also referred to herein as a graphic processing unit (GPU) fabric or AI accelerator fabric). End-to-end data center network 1 can also include front-end networks 101 through which users 199 can access data center backend network 100 in order to perform AI tasks (including a ML tasks). Those skilled in the art will recognize that data center backend network 110 is a primary component providing high-performance inter-device communication for Al-driven data centers. Generally, data center backend network 110 can be configured to support the demands of distributed AI workloads (e.g., training and inference) including, but not limited to, distributed memory sharing, gradient aggregation for large language models, collective communications in multi-node AI training, managing memory access operations requiring guaranteed delivery, and providing precise congestion control, etc. Data center backend network 100 can further be configured to provide quality-of-service specifications including, but not limited to, a guaranteed bandwidth (e.g., approximately 400/800 Gbps per device), low latency (e.g., around 2 microseconds (μs)), lossless transmission, and predictable performance under loaded conditions. Data center backend network 100 can include a scale-out network 110. This scale-out network can include a system of interconnected compute clusters (CCs) 120 (e.g., performance optimized datacenters (PODs)). Such CCs or PODs allow data centers to grow incrementally by adding new CCs or PODs. A scale-out network 110 typically facilitates communication between CCs 120 (e.g., connecting together thousands of accelerators) and utilizes remote direct access memory (RDMA) for efficient data transfer across CCs 120. Generally, such scale-out networks are well known in the art. Thus, the details thereof have been omitted from the specification in order to allow the reader to focus on the salient aspects of the disclose embodiments (e.g., related to the network infrastructure for communication within each, as discussed in greater detail below).

Within the scale-out network 110, each CC 120 (e.g., each POD) can include an internal network 121. This internal network 121 can, for example, be a scale-up network (i.e., have a scale-up topology) or, alternatively, can be a combined scale-up and scale-out network (i.e., have a scale-up and scale-out topology). In any case, each internal network 121 within a CC can include a group of nodes (N1-Nx) (e.g., three or more nodes). Furthermore, the total number of nodes N1-Nx within the different internal networks 121 in the different CCs 120 can be the same or different.

Each node N1-Nx within the internal network 121 of a CC 120 can include a system-on-package (SOP) structure (e.g., as illustrated in FIG. 1B).

Each SOP structure (e.g., SOP1 for N1, SOP2 for N2 . . . SOPx for Nx) can, for example, be implemented as a single network infrastructure chip. Alternatively, each SOP structure can be implemented as a network infrastructure chiplet and two or more (up to all) of the SOP structures (which are implemented as chiplets) could be integrated into the same chip.

Each SOP structure can include various components, which are interconnected and configured to perform, in combination, distributed, high-performance tasks for artificial intelligence (AI) and machine learning (ML) applications. Each SOP structure can be designed (e.g., customized) to support the desired networking operations. That is, as illustrated in FIG. 1B, each SOP structure can include multiple blocks. These blocks can include but are not limited to, a cores block 10, an external network interfaces block 20, a chip-to-chip interfaces block 30; a network-on-chip (NOC) fabric block 50; an internal network interfaces block 60; a peripherals block 70; and a subsystems block 80.

At least some of the blocks can include standard components found within an SOP structure for a node in a network. For example, cores block 10 can include one or more central processing unit (CPU) cores 11. Generally, in a networking environment, CPU cores can include the processors that perform computational task, etc. required networking device (e.g., switch, router, etc.) operation. For example, CPU core(s) execute instructions for managing data flow (e.g., packet processing, control plane tasks, data plane acceleration, parallel processing, etc.). External interfaces block 20 can include, for example, Ethernet interfaces or mediums (e.g., copper or fiber) to facilitate connecting the SOP structure to an Ethernet network. Speed of such an Ethernet interface or medium can be variable (e.g., depending on the networking application specifications) such as at 1G, 10G, 100G, 200G, 400G, 800G, etc. Internal network interfaces block 60 can include, for example, Ethernet physical (Phys) and media access control (MAC) layers that are compliant with IEE 802.3 standards. Chip-to-chip interfaces block can include, for example, a Universal Chiplet Interconnect Express (UCIe), which refers to an open industry standard that defines an interface for chiplet-to-chiplet connections within an SOP structure. Peripherals block 70 can include memories and buffers. NOC fabric block 50 can include an interconnect infrastructure including dedicated, high-bandwidth routing paths (e.g., routers and links) to provide communication between and, particularly, to move data efficiently between all of the various blocks (and components therein) within the SOP structure.

Subsystems block 80 can include multiple subsystems for facilitating (i.e., supporting) networking operations between nodes N1-Nx across the internal network 121. These networking operations can include, for example, scale-up operations including memory access operations including both conventional load and store operations and direct memory access (DMA) operations between any two nodes in the internal network 121. Additionally, or alternatively, these networking operations could include scale-out operations.

More specifically, subsystems within subsystems block 80 can include, but are not limited to, one or more instances of any of the following: an AI accelerator 81; host-side AI accelerator-side scale-up network interface subsystem(s) 83 that is/are compliant with any scale-up technology, such as Ultra Accelerator Link (UALink), Scale-Up Ethernet (SUE), Ethernet for Scale-Up Networking (ESUN), etc.; AI infrastructure scale-up switch subsystem(s) 82 (i.e., scale-up switch(es)) that is/are compliant with any scale-up technology, such as UALink switch(es), Scale-Up Ethernet (SUE) switch(es), Ethernet for Scale-Up Networking (ESUN) switch(es), etc.; AI infrastructure scale-out network interface subsystem(s) 85 that is/are compliant with any scale-out technology, such as Ultra Ethernet Consortium (UEC), etc.; and/or AI infrastructure scale-out switch subsystem(s) 84 (i.e., scale-out switch(es)) that is/are compliant with any scale-out technology, such as Ultra Ethernet Consortium (UEC) switch(es), etc.

Additional subsystems 86₁-86ₙ including within subsystems block 80 can include, but are not limited to, one or more instances of any of the following: AI infrastructure scale-across network interface subsystem(s) and/or scale-across switch subsystems (i.e., scale-across switch(es)) that is/are compliant with any scale-across technology; AI infrastructure in-network collective (INC) network interface subsystem(s); an Ethernet Data Plane for industrial or automotive networking applications; an Ethernet Switch for industrial or automotive networking applications; an Ethernet Router for industrial or automotive networking applications; an inline real time network packet processor; an inline network security processor (e.g., a transport layer security (TLS) processor); an inline faster and dedicated control plane packet processor; an inline faster telemetry processor; and an inline faster application processor (e.g., a network management processor (NMI)).

It should be understood that the list of subsystems provided above is not exhaustive and any other, now known or subsequently developed, subsystems suitable for supporting scale-up, scale-out, and/or scale-across networking functionality could be employed. As discussed in greater detail below, subsystems within the subsystems block 80 of each SOP structure employed in the disclosed network infrastructure embodiments can specifically be customized (as discussed in greater detail below) to facilitate efficient and cost-effective communications across the CC.

It should be noted that in addition to the CPU core(s) 11 mentioned above cores block 10 may also include one or more softcores 12₁-12ₘ (also referred to herein as optimized softcores), which are each specifically optimized for improving performance, power and/or area (PPA) of at least one networking function. Those skilled in the art will recognize that a softcore refers to a set of instructions (code) synthesized into programmable logic (e.g., a field-programmable gate array (FPGA)). Because a softcore is code-based (i.e., a set of instructions), it can be customized for a specific networking function or multiple different networking functions. Generally, the optimized softcores include sets of instructions (code) directed to a specific networking function or multiple networking functions and optimized (i.e., specifically designed) to improve performance, power and/or area (PPA) in a networking environment. Such optimized softcores can include, but are not limited to any of the following: in-order to high-performance out-of-order scalable multi-core; a high-efficiency multi-threading core; a high-level operating system (HLOS) core; a real-time operating system (RTOS) core; a core optimized for faster forwarding plane programming; a core optimized for inline processing including packet processing; a core optimized for control plane processing; a core optimized for telemetry processing; a core optimized for management processing; a core optimized for remote procedure call processing; a core optimized for network management interface processing; a core optimized for security; a core optimized for in-network collective processing; a core optimized to run any of applications and agents of the applications; and a core optimized for application-to-network stack interface processing. It should be noted that each of the above-mentioned optimized softcores are directed to one specific networking function. However, it should be understood any two or more of the above-mentioned optimized softcores could instead be combined into a single softcore (i.e., a single set of instructions) directed to two or more specific networking functions.

SOP structure components can further include multiple ports (P1-Pw). Such ports can provide access points for connecting specific internal SOP structure components to off-SOP structure components (e.g., to specific ports of other SOP structures within the network infrastructure, to a printed circuit board (PCB), etc.).

Embodiments of a network infrastructure disclosed herein can include an an arrangement of interconnected system-on-package (SOP) structures.

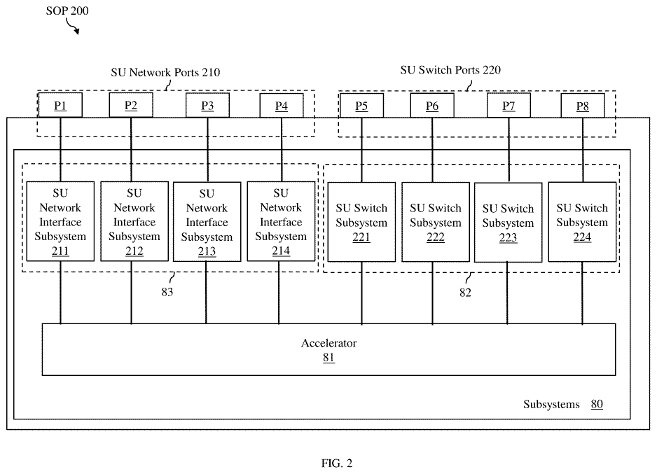

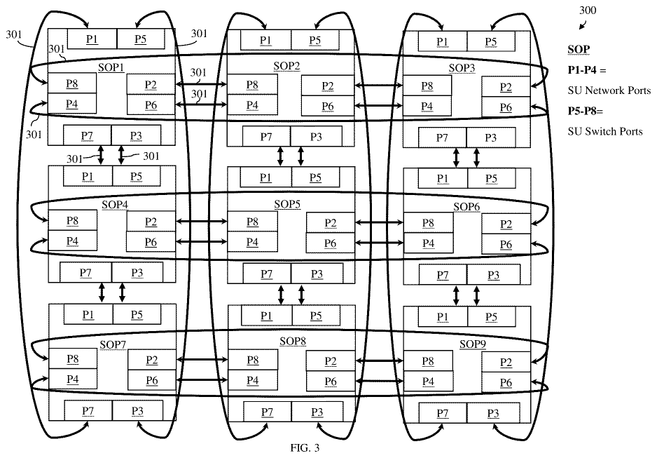

In some embodiments with a scale-up topology, all SOP structures within a particular arrangement of interconnected SOP structures can have similar configurations. For example, FIG. 2 is a schematic diagram illustrating a portion of one example of an SOP structure 200. FIG. 3 is a schematic diagram illustrating an embodiment of a scale-up network infrastructure 300 including an arrangement of interconnected SOP structures (e.g., configured as shown in FIG. 2). Generally, SOP structure 200 will have essentially the same components as the SOP structure of FIG. 1B except with customized subsystems as described below.

Referring to FIG. 2, SOP structure 200 can include a network subsystems block 80. Subsystems within the network subsystems block 80 can include an AI accelerator 81 and, coupled to the AI accelerator 81, multiple scale-up network interface subsystems 83 (see four scale-up network infrastructure subsystems 211-214) and multiple scale-up switch subsystems 82 (see four scale-up switch subsystems 221-224, also referred to herein as scale-up switches). The four scale-up network interface subsystems 211-214 and the four scale-up switches 221-224 can be compliant with a scale-up technology, such as Ultra Accelerator Link (UALink) technology. That is, scale-up network interface subsystems 211-214 can be UALinks and scale-up switches 221-224 can be UALink switches. Alternatively, the four scale-up network interface subsystems 211-214 and the four scale-up switches 221-224 can be compliant with any other suitable, now known or subsequently developed, scale-up technology.

SOP structure 200 can further include at least eight ports including four scale-up network ports 210 (e.g., UALink ports) and four scale-up switch ports 220 (e.g., UALink switch ports). The four scale-up network interface subsystems 211-214 can be coupled to corresponding ones of the four scale-up network ports 210. The four scale-up switches 221-224 can be coupled to corresponding ones of the four scale-up switch ports 220. For purposes of illustration, FIG. 2 shows ports P1-P4 as scale-up network ports 210 and ports P5-P8 as scale-up switch ports 220. Thus, in this example, scale-up network interface subsystem 211 is coupled to accelerator 81 and scale-up network port P1. Scale-up network interface subsystem 212 is coupled to accelerator 81 and scale-up network port P2. Scale-up network interface subsystem 213 is connected to accelerator 81 and scale-up network port P3. Scale-up network interface subsystem 214 is coupled to accelerator 81 and to scale-up network port P4. Additionally, scale-up switch 221 is coupled to accelerator 81 and scale-up switch port P5. Scale-up switch 222 is coupled to accelerator 81 and scale-up switch port P6. Scale-up switch 223 is coupled to accelerator 81 and scale-up switch port P7. Finally, scale-up switch 224 is coupled to accelerator 81 and scale-up switch port P8.

Referring to FIG. 3, an embodiment of a scale-up network infrastructure 300 disclosed herein can include a particular arrangement of interconnected SOP structures with each SOP structure having the same configuration as shown in FIG. 2. For purposes of illustration, network infrastructure 300 is shown in FIG. 3 as including nine SOP structures (SOP1-SOP9). Network infrastructure 300 can further include multiple scale-up network port-to-scale-up switch port interfaces 301 that interconnect all of the SOP structures SOP1-SOP9 either directly or indirectly and, thus, interconnect all of the accelerators thereof. Interconnection between the SOP structures is made through these network port-to-scale-up switch port interfaces 301 without the use of any external switches (i.e., without the use of switches outside SOP1-SOP9).

The nature of the scale-up network port-to-scale-up switch port interfaces 301 can vary depending upon the how the network is implemented. For example, if the SOPs (i.e., SOP1-SOP9) are on different chips, respectively, then the scale-up network port-to-scale-up switch port interfaces 301 can be formed using external interfaces or interconnects (e.g., external copper or fiber interconnects) that extend between the different chips. However, if the SOPs (i.e., SOP1-SOP9) are different chiplets and all on the same chip, then the scale-up network port-to-scale-up switch port interfaces 301 can be formed using less costly internal interfaces or interconnects (e.g., internal silicon photonic interfaces) that extend between the different chiplets. If the SOPs are different chiplets placed on just a few chips (e.g., SOP1-SOP4 on one chip and SOP5-SOP9 on another chip), then the scale-up network port-to-scale-up switch port interfaces 301 can be formed using a combination of external interfaces extending between the different chips and some less costly internal interfaces extending between the different chiplets on the same chip.

It should be noted that, within this arrangement, each scale-up network port P1-P4 on a first SOP structure (i.e., any one of the SOP structures SOP1-SOP9) is connected by a scale-up network port-to-scale-up switch port interface 301 to a switch port P5-P8 on a second SOP structure (i.e., on a different one of the SOP structures SOP1-SOP9) and vice versa. These scale-up network port-to-scale-up switch port interfaces 301 can be placed so as to connect the scale-up network ports and scale-up switch ports in a manner that ensures: (1) at least some of the SOP structures SOP1-SOP9 within network infrastructure 300 are directly connected; (2) all SOP structures SOP1-SOP9 within network infrastructure 300 are connected either directly, or indirectly through an intermediate SOP; (3) the total number of direct connections between SOP structures within the network infrastructure 300 is maximized; and (4) the number of intermediate SOP structures indirectly connecting any two SOP structures within network infrastructure 300 is minimized.

It should be noted that, for purposes of this disclosure, a direct connection between two SOP structures (e.g., between a first SOP structure and a second SOP structure) means the connection is made by at least one network port-to-switch port interface (e.g., an interface between a network port on the first SOP structure and a switch port on the second SOP structure or vice versa). A bi-directional direct connection between two SOP structures (e.g., between a first SOP structure and a second SOP structure) means connections between the two SOP structures include two network port-to-switch port interfaces including: one interface between a network port on the first SOP structure and a switch port on the second SOP structure and another interface from a network port on the second SOP structure and a switch port on the first SOP structure. An indirect connection between two SOP structure means the connection(s) between the two SOP structures is/are made by a combination of network port-to-switch port interfaces and switch(es) on intermediate SOP structure(s).

Within the nine-SOP structure arrangement of FIG. 3, each SOP structure has a bi-directional direct connection with four SOP structures (in order to connect its accelerator to the accelerators of those four SOP structures). Additionally, each SOP structure has an indirect connection with four other SOP structures (in order to connect its accelerator to the accelerators of those four other SOP structures). As discussed below, within the nine-SOP arrangement of FIG. 3, there can be multiple indirect connection pathways between any two SOP structures.

For example, as illustrated in FIG. 3, SOP1 is bi-directionally directly connected to SOP2, SOP3, SOP4 and SOP 7 and indirectly connected to SOP5, SOP6, SOP8 and SOP9. SOP2 is bi-directionally directly connected to SOP1, SOP3, SOP5 and SOP8 and indirectly connected to SOP4, SOP6, SOP7 and SOP9. SOP3 is bi-directionally directly connected to SOP1, SOP2, SOP6 and SOP9 and indirectly connected to SOP4, SOP5, SOP7 and SOP8. SOP4 is bi-directionally directly connected to SOP1, SOP7, SOP5 and SOP6 and indirectly connected to SOP2, SOP3, SOP8 and SOP9. Similar bi-directional direct connections and indirect connections can be traced in network infrastructure 300 of FIG. 3 for SOP5 through SOP8.

More specifically, consider SOP1, its direct connections to SOP2, SOP3, SOP4 and SOP7, and its indirect connections to SOP5, SOP6, SOP8 and SOP9.

A bi-directional direct connection between SOP1 and SOP2 includes a first interface 301 between SU network port P2 of SOP1 and SU switch port P8 of SOP2 and a second interface 301 between SU network port P4 of SOP2 and SU switch port P6 of SOP1. A bi-directional direct connection between SOP1 and SOP3 includes a first interface 301 between SU network port P4 of SOP1 and SU switch port P6 of SOP3 and a second interface 301 between SU network port P2 of SOP3 and SU switch port P8 of SOP1. A bi-directional direct connection between SOP1 and SOP4 includes a first interface 301 between SU network port P3 of SOP1 and SU switch port P5 of SOP4 and a second interface 301 between SU network port P1 of SOP4 and SU switch port P7 of SOP1. A bi-directional direct connection between SOP1 and SOP7 includes a first interface 301 between SU network port P1 of SOP1 and SU switch port P7 of SOP7 and a second interface 301 between SU network port P3 of SOP7 and SU switch port P5 of SOP1. These bi-directional direct connections connect the accelerator 81 of SOP1 to the accelerators of each of SOP2, SOP3, SOP4 and SOP7.

Additionally, an indirect connection between SOP1 and SOP5 includes the first and second interfaces mentioned above between SOP1 and SOP2 (an intermediate SOP structure) and also a first interface 301 between SU network port P3 of SOP2 and SU switch port P5 of SOP5 and a second interface 301 between SU network port P1 of SOP5 and SU switch port P7 of SOP2. Another indirect connection between SOP1 and SOP5 includes the first and second interfaces mentioned above between SOP1 and SOP4 (an intermediate SOP structure) and also a first interface 301 between SU network port P2 of SOP4 and SU switch port P8 of SOP5 and a second interface 301 between SU network port P4 of SOP5 and SU switch port P6 of SOP4. An indirect connection between SOP1 and SOP6 includes the first and second interfaces mentioned above between SOP1 and SOP3 (an intermediate SOP structure) and also a first interface 301 between SU network port P3 of SOP3 and SU switch port P5 of SOP6 and a second interface 301 between SU network port P1 of SOP6 and SU switch port P7 of SOP3. Another indirect connection between SOP1 and SOP6 includes the first and second interfaces discussed herein between SOP1 and SOP4 (an intermediate SOP structure) and also a first interface 301 between SU network port P4 of SOP 4 and SU switch port P6 of SOP6 and a second interface 301 between SU network port P6 of SOP6 and SU switch port P8 of SOP4. An indirect connection between SOP1 and SOP8 includes the first and second interfaces mentioned above between SOP1 and SOP7 (an intermediate SOP structure) and a first interface 301 between SU network port P2 of SOP7 and SU switch port P8 of SOP8 and a second interface 301 between SU network port P4 of SOP8 and SU switch port P6 of SOP7.

Another indirect connection between SOP1 and SOP8 includes the first and second interfaces mentioned above between SOP1 and SOP2 (an intermediate SOP structure) and also a first interface 301 between SU network port P1 of SOP2 and SU switch port P7 of SOP8 and a second interface 301 between SU network port P3 of SOP8 and SU switch port P5 of SOP3. An indirect connection between SOP1 and SOP9 includes the first and second interfaces mentioned above between SOP1 and SOP3 (an intermediate SOP structure) and also a first interface 301 between SU network port P1 of SOP3 and SU switch port P7 of SOP9 and a second interface 301 between SU network port P3 of SOP9 and SU switch port P5 of SOP3. Another indirect connection between SOP1 and SOP9 includes the first and second interfaces mentioned above between SOP1 and SOP7 (an intermediate SOP structure) and also a first interface 301 between SU network port P4 of SOP7 and SU switch port P6 of SOP9 and a second interface 301 between SU network port P2 of SOP9 and SU switch port P8 of SOP3. These indirect connections connect the accelerator 81 of SOP1 to the accelerators of each of SOP5, SOP6, SOP8 and SOP9.

Similar bi-directional direct connections, and indirect connections can be traced in network infrastructure 300 of FIG. 3 for each of the other SOP structures (SOP2-SOP9).

The particular arrangement of interconnected SOP structures SOP1-SOP9 illustrated in network infrastructure 300 of FIG. 3 avoids the cost of external switches, unreliable external cables, and copper, fiber module, or optical interfaces otherwise needed to make accelerated side and switch side connections. It should be understood that the indirect connections will add latency to network processing over the direct connections. Additionally, it should be understood that for larger network infrastructures where each indirect connection between two SOP structures requires multiple intermediate SOP structures, congestion and errors may become a concern. In this case, a controller can be included and configured to provide congestion control and error correction when needed. Furthermore, it should be understood that within each SOP structure SOP1-SOP9, subsystems within network subsystems block 80 will provide all support for control plane, configuration/management plane, and inline packets processing for such a topology to work for remote memory access semantics (i.e., networking subsystem 81 would provide conversion from networking to memory semantics and vice versa).

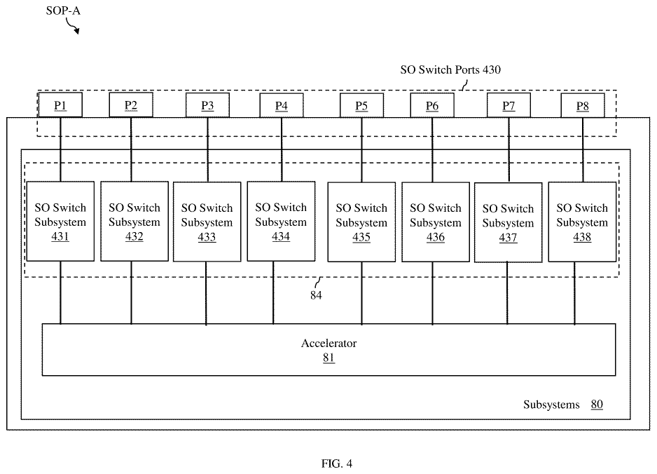

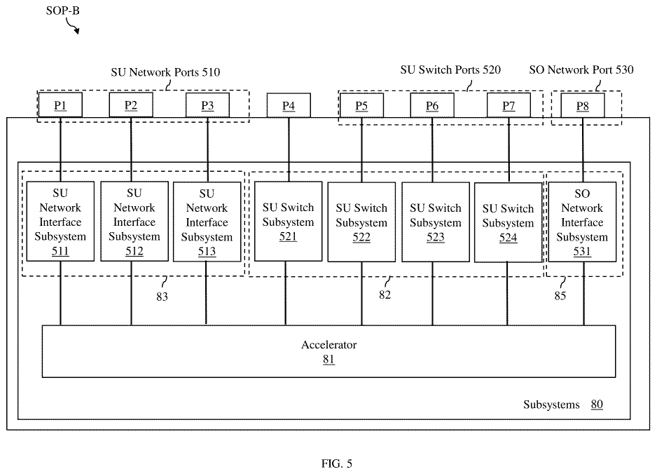

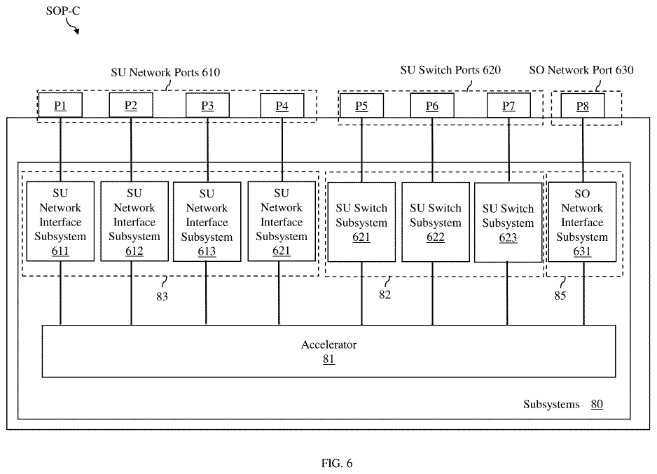

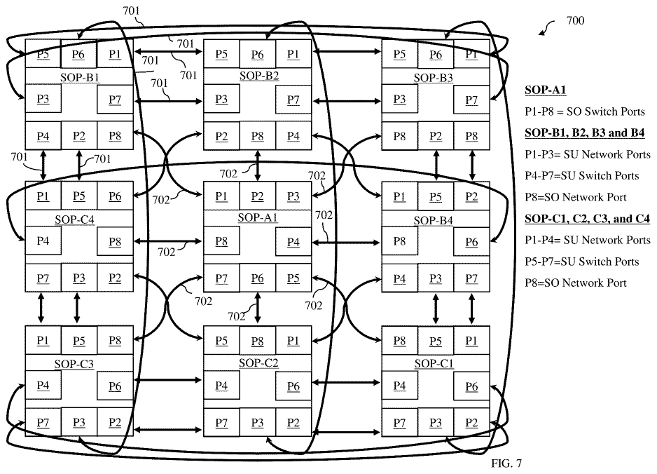

In other embodiments (e.g., embodiments with a combined scale-up and scale-out topology), some of the SOP structures within a particular arrangement of interconnected SOP structures may have different configurations. For example, FIG. 4 is a schematic diagram illustrating a portion of an example of an SOP structure with a first configuration (SOP-A). FIGS. 5 and 6 are schematic diagrams illustrating portions of examples of two additional SOP structures with a second configuration (SOP-B) and a third configuration (SOP-C), respectively. FIG. 7 is a schematic diagram illustrating another embodiment of a network infrastructure 700 (and particularly a combined scale-up and scale-out network infrastructure) including an arrangement of interconnected SOP structures with three different configurations (including SOP-A, SOP-B, and SOP-C). Generally, SOP-A, SOP-B and SOP-C will each have essentially the same components as the SOP structure of FIG. 1B except that the subsystems of the network subsystems block 80 will be customized as described below.

Referring to FIG. 4, SOP-A can include a network subsystems block 80 including an accelerator 81 and, coupled to the accelerator, multiple scale-out switch subsystems 84 (e.g., see eight scale-out switch subsystems 431-438, also referred to herein as scale-out switches). The scale-out switches 431-438 can be compliant with a scale-out technology, such as Ultra Ethernet Link (UELink) technology. That is, scale-out switches 431-438 can be UELink switches. Alternatively, the scale-out switches 431-438 can be compliant with any other suitable, now known or subsequently developed, scale-out technology. SOP-A can further include at least eight scale-out switch ports 430 (UELink switch ports) (see ports P1-P8). Scale-out switch subsystems 431-438 can further be coupled to corresponding ones of the scale-out switch ports 430. For purposes of illustration, FIG. 4 shows ports P1-P8 as scale-out switch ports 430 connected to scale-out switches 431-438, respectively.

Referring to FIG. 5, SOP-B can include a network subsystems block 80 including an accelerator 81 and, coupled to the accelerator 81, a scale-out network interface subsystem 85 (see one scale-out network interface subsystem 531), multiple scale-up network interface subsystems 83 (see three scale-up network interface subsystems 511-513), and multiple scale-up switch subsystems 82 (see three scale-up switch subsystems 521-524, also referred to herein as scale-up switches). The scale-out network interface subsystem 531 can be compliant with a scale-out technology (and particularly the same scale-out technology as the scale-out switches 431-438 of SOP-A of FIG. 4). The scale-up network interface subsystems 511-513 and scale-up switches 521-524 can be compliant with a scale-up technology, such as Ultra Accelerator Link (UALink) technology. That is, scale-up network interface subsystems 511-513 can be UALinks and scale-up switches 521-524 can be UALink switches. Alternatively, the scale-up network interface subsystems and the scale-up switches can be compliant with any other suitable, now known or subsequently developed, scale-up technology.

SOP-B can further include multiple ports including a scale-out network port 530, three scale-up network ports 510 (e.g., UALink ports), and four scale-up switch ports 520 (e.g., UALink switch ports). Scale-out network interface subsystem 531 can be coupled to scale-out network port 530. Scale-up network interface subsystems 511-513 can be coupled to corresponding ones of the scale-up network ports 510. Scale-up switches 521-524 can be coupled to corresponding ones of the scale-up switch ports 520. For purposes of illustration, FIG. 5 shows port P8 as scale-out network port 530, ports P1-P3 as scale-up network ports 510, and ports P4-P7 as scale-up switch ports 520. Thus, in this example, scale-out network interface subsystem 531 is coupled to accelerator 81 and to scale-out network port P8. Scale-up network interface subsystem 511 is coupled to accelerator 81 and scale-up network port P1. Scale-up network interface subsystem 512 is coupled to accelerator 81 and scale-up network port P2. Scale-up network interface subsystem 513 is coupled to accelerator 81 and scale-up network port P3. Additionally, scale-up switch 521 is coupled to accelerator 81 and scale-up switch port P4. Scale-up switch 522 is coupled to accelerator 81 and scale-up switch port P5. Scale-up switch 523 is coupled to accelerator 81 and scale-up switch port P6. Finally, scale-up switch 524 is coupled to accelerator 81 and scale-up switch port P7.

Referring to FIG. 6, SOP-C can include an accelerator 81 and, coupled to accelerator 81, one scale-out network interface subsystem 85 (see the scale-out network interface subsystem 631), multiple scale-up network interface subsystems 82 (see the four scale-up network interface subsystems 611-614), and multiple scale-up switch subsystems 82 (see the three scale-up switch subsystems 621-623, also referred to herein as scale-up switches). The scale-out interface subsystem 631 can be compliant with a scale-out technology (and particularly the same scale-out technology as the scale-out switches 431-438 of SOP-A of FIG. 4). The scale-up network interface subsystems 611-614 and scale-up switches 621-623 can be compliant with the same scale-up technology as the scale-up network interface subsystems and scale-up switches of SOP-B of FIG. 5.

SOP-C can further include multiple ports including one scale-out network port 630, four scale-up network ports 610 (e.g., UALink ports), and three scale-up switch ports 620 (e.g., UALink switch ports). Scale-out network interface subsystem 631 can be coupled to scale-out network port 630. Scale-up network interface subsystem 611-614 can be coupled to corresponding ones of the scale-up network ports 610. Scale-up switches 621-623 can be coupled to corresponding ones of the scale-up switch ports 620. For purposes of illustration, FIG. 6 shows port P8 as scale-out network port 630, ports P1-P4 as scale-up network ports 610, and ports P5-P7 as scale-up switch ports 620. Thus, in this example, scale-out network interface subsystem 631 is coupled to accelerator 81 and to scale-out network port P8. Scale-up network interface subsystem 611 is coupled to accelerator 81 and scale-up network port P1. Scale-up network interface subsystem 612 is coupled to accelerator 81 and scale-up network port P2. Scale-up network interface subsystem 613 is coupled to accelerator 81 and scale-up network port P3. Scale-up network interface subsystem 614 is coupled to accelerator 81 and scale-up network port P4. Scale-up switch 621 is coupled to accelerator 81 and scale-up switch port P5. Scale-up switch 622 is coupled to accelerator 81 and scale-up switch port P6. Finally, scale-up switch 623 is coupled to accelerator 81 and scale-up switch port P7. Thus, SOP-B and SOP-C are similar except that SOP-B has one more scale-up network interface and one less scale-up switch than SOP-C.

Referring to FIG. 7, an embodiment of a combined scale-up and scale-out network infrastructure 700 can include a particular arrangement of interconnected SOP structures having three different SOP structure configurations (including SOP-A as shown in FIG. 4 and described below, SOP-B as shown in FIG. 5 and described below, and SOP-C). For purposes of illustration, network infrastructure 700 is shown in FIG. 7 as including nine SOP structures including: one SOP structure with the SOP-A configuration of FIG. 4 (see SOP-A1), four first additional SOP structure with the SOP-B configuration of FIG. 5 (see SOP-B1, SOP-B2, SOP-B3, and SOP-B4) and three second additional SOP structures with the SOP-C configuration of FIG. 6 (see SOP-C1, SOP-C2, and SOP-C3).

Network infrastructure 700 can further include both scale-out network port-to-scale-out switch port interfaces 702 and scale-up network port-to-scale-up switch port interfaces 701, as discussed below, to interconnect all of the SOP structures directly or indirectly and, thus, interconnect all of the accelerators of the SOP structures.

The nature of the scale-out network port-to-scale-out switch port interfaces 702 and of the scale-up network port-to-scale-up switch port interfaces 701 can vary depending upon the how the network is implemented. For example, if the SOPs (i.e., SOP-A1, SOP-B1, SOP-B2, SOP-B3, SOP-B4, SOP-C1, SOP-C2, and SOP-C3) are on different chips, respectively, then the scale-out network port-to-scale-out switch port interfaces 702 and scale-up network port-to-scale-up switch port interfaces 701 can be formed using external interfaces or interconnects (e.g., external copper or fiber interconnects) that extend between the different chips.

However, if the SOPs are different chiplets and all on the same chip, then the scale-out network port-to-scale-out switch port interfaces 702 and scale-up network port-to-scale-up switch port interfaces 701 can be formed using less costly internal interfaces or interconnects (e.g., internal silicon photonic interfaces) that extend between the different chiplets. If the SOPs are different chiplets placed on just a few chips (e.g., SOP-A1, SOP-C1, SOP-C2, and SOP-C3 on one chip and SOP-B1, SOP-B2, SOP-B3, and SOP-B4 on another chip), then the scale-out network port-to-scale-out switch port interfaces 702 and scale-up network port-to-scale-up switch port interfaces 701 can be formed using some external interfaces that extend between the different chips and some less costly internal interfaces that extend between the different chiplets on the same chip.

As illustrated in FIG. 7, scale-out network port-to-scale-out switch port interfaces 702 provide direct connections between scale-out switch ports P1-P8 of SOP-A1 and the scale-out network ports P8 on all other SOP structures within the arrangement (i.e., on first additional SOP structures SOP-B1, SOP-B2, SOP-B3, and SOP-B4 and on second additional SOP-C1, SOP-C2, and SOP-C3). Scale-up network port-to-scale-up switch port interfaces 701 can be placed so as to connect the scale-up network ports and scale-up switch ports in the first and second additional SOP structures (i.e., SOP-B1, SOP-B2, SOP-B3, and SOP-B4 and SOP-C1, SOP-C2, and SOP-C3) in a manner that ensures: (1) at least some of the first and second additional SOP structures within network infrastructure 700 are directly connected; (2) all additional SOP structures within network infrastructure 700 are connected either directly, or indirectly through an intermediate SOP; (3) the total number of direct connections between SOP structures within the network infrastructure 700 is maximized; and/or (4) the number of intermediate SOP structures indirectly connecting any two SOP structures within network infrastructure 700 is minimized.

As noted above, for purposes of this disclosure, a direct connection between two SOP structures (e.g., between a first SOP structure and a second SOP structure) means the connection is made by at least one network port-to-switch port interface (e.g., an interface between a network port on the first SOP structure and a switch port on the second SOP structure or vice versa). A bi-directional direct connection between two SOP structures (e.g., between a first SOP structure and a second SOP structure) means connections between the two SOP structures include one interface between a network port on the first SOP structure and a switch port on the second SOP structure and another interface from a network port on the second SOP structure and a switch port on the first SOP structure. An indirect connection between two SOP structure means the connection(s) between the two SOP structures is/are made by a combination of network port-to-switch port interfaces and intermediate SOP structure(s).

Because of the inclusion of SOP-A1 with only scale-out switches and, thus, the need for each of the first and second additional SOP structures (i.e., SOP-B1, SOP-B2, SOP-B3, and SOP-B4 and SOP-C1, SOP-C2, and SOP-C3) to have a scale-out network port (P8) not all of the direct connections between a pair of additional SOP structures are bi-directional. Furthermore, in one direction two additional SOP structures may be directly connected and in the opposite direction they may be indirectly connected.

For example, as illustrated in FIG. 7, SOP-B1 is bi-directionally directly connected to SOP-B2, SOP-B3, and SOP-C4, directly connected to SOP-C3 in only one direction (i.e., see interface 701 between scale-up network port P4 of SOP-C3 and scale-up switch port P6 of SOP-B1), and indirectly connected to SOP-B4, SOP-C1, and SOP-C2. In this case, the connection between a scale-up switch port of SOP-C3 and a scale-up network port of SOP-B1 can be made, for example, through an indirect connection with SOP-C4 as an intermediate SOP structure. SOP-B2 is bi-directionally directly connected to SOP-B1 and SOP-B3, directly connected to SOP-C3 in only one direction (i.e., see interface 701 between scale-up network port P3 of SOP-C2 and scale-up switch port P6 of SOP-B2), directly connected to SOP-C4 in only one direction (i.e., see interface 701 between scale-up network port P2 of SOP-B2 and scale-up switch port P6 of SOP-C4), directly connected to SOP-B4 in only one direction (i.e., see interface between scale-up network port P1 of SOP-B4 and scale-up switch port P4 of SOP-B2), and indirectly connected to SOP-C3 and SOP-C1. In this case, the connections between SOP-B2 and SOP-C3, between SOP-B2 and SOP-C4, and between SOP-B2 and SOP-B4 in the opposite directions can again be made through indirect connections. That is, a connection between a scale-up network port of SOP-B2 and scale-up switch port of SOP-C2 can be made through an indirect connection with, for example, SOP-C4 as an intermediate SOP structure. A connection between a scale-up network port of SOP-C4 and scale-up switch port of SOP-B2 can be made through an indirect connection with, for example, SOP-B1 as an intermediate SOP structure. A connection between a scale-up network port of SOP-B2 and scale-up switch port P4 of SOP-B4 can be made through an indirect connection with, for example, SOP-B3 as the intermediate SOP structure.

Similar bi-directional direct connections, uni-directional direct connections, and indirect connections can be traced in network infrastructure 700 of FIG. 7 for each of the other additional SOP structures (SOP-B3, SOP-B4, SOP-C1, SOP-C2, and SOP-C3). However, as noted above, indirect connections that employ intermediate SOP structure(s) will typically add latency to network processing and may raise congestion control and error concerns. With the combined scale-up and scale-out topology employ in network infrastructure 700 of FIG. 7, SOP-A could be used as an intermediate SOP (as opposed to one of the additional SOP structures with the SOP-B or SOP-C configuration) to support an indirect connection between any two of the additional SOP structures. This combined scale-up and scale-out topology may be advantageous because congestion control and error handling can be handled internally due to scale-out network congestion control and error handling capabilities (e.g., due to Ultra Ethernet Consortium (UEC) congestion control and error handling capabilities).

In any case, like the arrangement of interconnected SOP structures shown in the network infrastructure 300 of FIG. 3, the particular arrangement of interconnected SOP structures SOP-A1, SOP-B1, SOP-B2, SOP-B3, SOP-B4, SOP-C1, SOP-C2, and SOP-C3 shown in the network infrastructure 700 of FIG. 7 avoids the cost of external switches, unreliable external cables, and copper, fiber module, or optical interfaces otherwise needed to make accelerated and switch sides connections. Furthermore, it should be understood that within each SOP structure, subsystems within network subsystems block 80 can also provide all support for control plane, configuration/management plane, and inline packets processing for such a topology to work for remote memory access semantics (i.e., networking subsystem 81 would provide conversion from networking to memory semantics and vice versa).

The network infrastructure 700 shown in FIG. 7 (including SOP structures with multiple configurations including SOP-A, SOP-B, and SOP-C) not only provides a reduced-cost scale-up and scale-out network (including, for example, UALink and UEC technologies), it ensures flexibility, scalability, and performance in remote accelerator memory access catering to the unique data and network traffic characteristics of diverse Al/ML applications. By addressing both scale-up and scale-out functionalities at reduced cost in SOP structures through subsystems of network subsystems block 80 that are both customizable and interoperable, this network infrastructure 700 sets the foundation for the next generation of AI network infrastructure for different use cases. Such a network subsystems block 80 provides integrated management and control planes for the network infrastructure 700 to support remote accelerator memory access (load/store and remote direct memory access (RDMA).

Thus, the proposed solutions discussed above provide significant advantages in simplifying network operations and enhancing overall operational efficiency in remote memory access for Al Infra. A unified plane streamlines monitoring, configuration, and orchestration processes, reducing the operational overhead associated with managing separate solutions. This integration enables consistent policy enforcement, accelerates troubleshooting, and enhances real-time adaptability to dynamic workloads. Furthermore, a single pane of glass management and unified control plane also fosters better resource utilization, improved security, and scalability by offering a cohesive framework supporting seamless integration of diverse applications and evolving traffic patterns. As AI workloads evolve in complexity, the flexibility to adapt the network infrastructure (e.g., via the customizable network subsystems block 80) to diverse organizational needs, Al/ML mode types, and traffic patterns becomes paramount. The network infrastructure embodiments for AI/ML applications, as disclosed herein, offer the necessary adaptability to maintain high performance across different use cases. Since the complexity of managing optimized solutions is challenging, the optimized softcores 12₁-12ₘ with each SOP structures (discussed above and illustrated in FIG. 1B) bring in the needed simplification with the long-term benefits of performance, security, and scalability justifying this approach. This ultimately supports the seamless integration of diverse AI/ML applications.

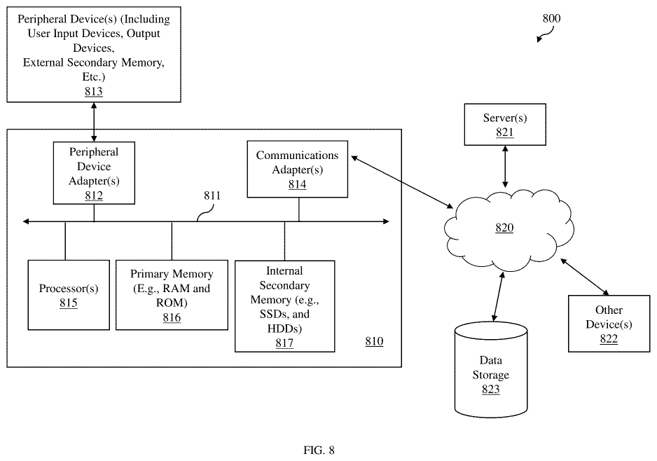

Aspects of the disclosed embodiments may be implemented in hardware and/or software (e.g., as computer program product). An illustrative hardware environment 800 for implementing aspects of the disclosed embodiments is depicted in FIG. 8. Generally, the hardware environment can include at least one computing device 810 (also referred to herein as a computer). Computer 810 can be, for example, a desktop, laptop, tablet, mobile computing device, etc. Computer 810 can include at least one bus 811. Bus 811 can be connected to various other components of computer 810 and can be configured to facilitate communication between those components.

Computer 810 can include various adapters. The adapters can include one or more peripheral device adapters 812, which are configured to facilitate communications between one or more peripheral devices 813, respectively, and bus 811. Peripheral devices 813 can include user input devices configured to receive user inputs. User input devices can include, but are not limited to, a keyboard, a mouse, a microphone, a touchpad, a touchscreen, a stylus, biosensor, a scanner, or any other type of user input device. The peripheral devices 813 can also include additional input devices, such as external secondary memory devices (as discussed in greater detail below). Peripheral devices 813 can also include output devices. The output devices can include, but are not limited to, a printer, a monitor, a speaker, or any other type of computer output device. The adapters can include one or more communications adapters 814 (also referred to herein as a computer network adapters), which are configured to facilitate communications between computer 810 and one or more communications networks 820 (e.g., a wide area network (WAN), a local area network (LAN), the internet, a cellular network, a Wi-Fi network, etc.). Such communications network(s) 820 can, in turn, facilitate communication between computer 810 and other system components on the network: remote server(s) 821, other device(s) 822 (e.g., computers, laptops, tablets, mobile phones, etc.), remote data storage 823, etc.

Computer 810 can further include at least one processor 815 (also referred to herein as a central processing units (CPU)). Optionally, each CPU 815 can include a CPU cache. Each CPU 815 can be configured to read and execute program instructions.

Computer 810 can further include memory and, particularly, computer-readable storage mediums. The memory can include primary memory 816 and secondary memory. Primary memory 816 can include, but is not limited to, random access memory (RAM) (e.g., volatile memory employed during execution of program operations) and read only memory (ROM) (e.g., non-volatile memory employed during start-up). The RAM can include, but is not limited to, dynamic random access memory (DRAM), static random access memory (SRAM), or any other suitable type of RAM. The ROM can include, but is not limited to, erasable programmable read only memory (EPROM), flash memory, electronically erasable programmable read only memory (EEPROM), programmable read only memory (PROM), or any other suitable type of ROM. The secondary memory can be non-volatile. The secondary memory can include internal secondary memory 817, such as internal solid state drive(s) (SSD(s)) and/or internal hard disk drive(s) (HDD(s), installed within computer 810 and connected to bus 811. The secondary memory can also include external secondary memory connected to or otherwise in communication with the computer 810 (e.g., peripheral devices). The external secondary memory can include, for example, external/portable SSD(s), external/portable HDD(s), flash drive(s), thumb drives, compact disc(s) (CD(s)), digital video disc(s) (DVD(s)), network-attached storage (NAS), storage area network (SAN), or any other suitable non-transitory computer-readable storage media connected to or otherwise in communication with the computer 810. The different functions of primary and secondary memory are well known in the art and, thus, the details thereof have been omitted from this specification in order to allow the reader to focus on the salient aspects of the disclosed embodiments.

In some embodiments, program instructions for performing the disclosed method or a portion thereof, as described above, can be embodied in (e.g., stored in) secondary memory accessible by computer 810. When the program instructions are to be executed (e.g., in response to user inputs to computer 810), required information (e.g., the program instructions and other data) can be loaded into the primary memory (e.g., stored in RAM). CPU 815 can read the program instructions and other data from the RAM and can execute the program instructions. In other embodiments, a client-server model can be employed. In this case, computer 810 can be a client and a remote server 821 in communication with computer 810 over a network 820 can provide, to the client, a service including execution of program instructions for performing the disclosed method or a portion thereof, as described above, in response to user inputs to computer 810.

It should be understood that the terminology used herein is for the purpose of describing the disclosed structures and methods and is not intended to be limiting. For example, as used herein, the singular forms “a,” “an,” and “the” are intended to include the plural forms as well, unless the context clearly indicates otherwise. Additionally, as used herein, the terms “comprises,” “comprising,” “includes,” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right,” “left,” “vertical,” “horizontal,” “top,” “bottom,” “upper,” “lower,” “under,” “below,” “underlying,” “over,” “overlying,” “parallel,” “perpendicular,” etc., are intended to describe relative locations as they are oriented and illustrated in the drawings (unless otherwise indicated) and terms such as “touching,” “in direct contact,” “abutting,” “directly adjacent to,” “immediately adjacent to,” etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings. For example, an element that is positioned laterally adjacent to another element will be beside the other element, an element that is positioned laterally immediately adjacent to another element will be directly beside the other element, and an element that laterally surrounds another element will be adjacent to and border the outer sidewalls of the other element. The corresponding structures, materials, acts, and equivalents of all means or step plus function elements in the claims below are intended to include any structure, material, or act for performing the function in combination with other claimed elements as specifically claimed.

The descriptions of the various disclosed embodiments have been presented for purposes of illustration but are not intended to be exhaustive or limiting. Many modifications and variations will be apparent to those of ordinary skill in the art without departing from the scope and spirit of the disclosed embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
system-on-package (SOP) structures, wherein each SOP structure includes:
switch ports;
network ports;
a network subsystems block including:
switch subsystems coupled to the switch ports, respectively;
network interface subsystems coupled to the network ports, respectively; and
an accelerator coupled to the switch subsystems and the network interface subsystems; and
network port-to-switch port interfaces between the SOP structures.

2. The structure of claim 1, wherein the network interface subsystems include scale-up network interfaces, and the switch subsystems include scale-up switches.

3. The structure of claim 1, wherein the network interface subsystems include Ultra Accelerator Links (UALinks) and wherein the switch subsystems include Ultra Accelerator Link (UALink) switches.

4. The structure of claim 1, wherein each network port on any one of the SOP structures is connected by a network port-to-switch port interface to a switch port on a different one of the SOP structures.

5. The structure of claim 1, wherein at least some of the SOP structures are connected directly by two network port-to-switch port interfaces.

6. The structure of claim 5, wherein the two network port-to-switch port interfaces between a first SOP structure of the SOP structures directly connected to a second SOP structure of the SOP structures include: one interface between a network port of the first SOP structure and a switch port of the second SOP structure; and another interface between a network port of the second SOP structure and a switch port of the first SOP structure.

7. The structure of claim 1, wherein at least some of the SOP structures are connected indirectly through at least one intermediate SOP structure.

8. The structure of claim 1, wherein each SOP structure includes a number N of network interface subsystems coupled to a same number N of network ports, respectively; and a same number N of switch subsystems coupled to the same number N of switch ports, respectively.

9. The structure of claim 1,
wherein the SOP structures include nine SOP structures, and
wherein each SOP structure is directly coupled to four of the SOP structures and indirectly coupled to a different four of the SOP structures.

10. The structure of claim 1, wherein the SOP structures are interconnected without external switches.

11. A structure comprising:
system-on-package (SOP) structures including:
an SOP structure including:
scale-out switch ports; and
a network subsystems block including:
scale-out switch subsystems coupled to the scale-out switch ports, respectively; and
an accelerator coupled to the scale-out switch subsystems; and
additional SOP structures, wherein each additional SOP structure includes:
a scale-out network port;
scale-up network ports;
scale-up switch ports;
an additional network subsystems block including:
a scale-out network interface subsystem coupled to the scale-out network port;
scale-up network interface subsystems coupled to the scale-up network ports, respectively;
scale-up switch subsystems coupled to the scale-up switch ports, respectively; and
an additional accelerator coupled to the scale-out network interface subsystem, the scale-up network interface subsystems, and the scale-up switch subsystems;
scale-out network port-to-scale-out switch port interfaces between the SOP structure and each of the additional SOP structures; and
scale-up network port-to-scale-up switch port interfaces between the additional SOP structures.

12. The structure of claim 11, wherein the scale-out network interface subsystem of each additional SOP structure includes an Ultra Ethernet Link and wherein the scale-out switch subsystems of the SOP structure include Ultra Ethernet switches.

13. The structure of claim 11, wherein the additional SOP structures include eight additional SOP structures including four first additional SOP structures and four second additional SOP structures.

14. The structure of claim 13,
wherein four of the additional SOP structure each include three scale-up network interface subsystems and four scale-up switch subsystems, and
wherein a different four of the additional SOP structure each include four scale-up network interface subsystems and three-scale-up switch subsystems.

15. The structure of claim 11, wherein the scale-up network interface subsystems include Ultra Accelerator Links (UALinks) and wherein the scale-up switch subsystems include Ultra Accelerator Link (UALink) switches.

16. The structure of claim 11, wherein at least some of the additional SOP structures are connected directly by two scale-up network port-to-scale-up switch port interfaces.

17. The structure of claim 16, wherein the two scale-up network port-to-scale-up switch port interfaces between a first additional SOP structure of the additional SOP structures directly connected to a second additional SOP structure of the additional SOP structures include: one interface between a scale-up network port of the first additional SOP structure and a scale-up switch port of the second additional SOP structure; and another interface between a scale-up network port of the second additional SOP structure and a scale-up switch port of the first additional SOP structure.

18. The structure of claim 16, wherein at least some of the additional SOP structures are connected indirectly through at least one intermediate additional SOP structure.

19. The structure of claim 16, wherein each additional SOP structure is directly connected to four other additional SOP structures and indirectly connected to a different three of the additional SOP structures.

20. The structure of claim 11, wherein the SOP structure and the additional SOP structures are interconnected without external switches.
